(19) United States
(12) Patent Application Publication
(10) Pub. No.: US 2015/0050032 A1
(43) Pub. Date: Feb. 19, 2015

(54) DIGITALLY LOCKING COHERENT RECEIVER AND METHOD OF USE THEREOF

(71) Applicant: Alcatel-Lucent USA, Inc., Murray Hill, NJ (US)

(72) Inventor: Joseph K. Kakande, Holmdel, NJ (US)

(73) Assignee: Alcatel-Lucent USA, Inc., Murray Hill, NJ (US)

(21) Appl. No.: 13/965,402

(22) Filed: Aug. 13, 2013

(51) Int. Cl. H04B 10/61; H04L 7/00; H04B 10/63

(52) U.S. Cl. CPC H04B 10/6164; H04B 10/63; H04L 7/0079; H04L 7/0075
USPC 398/203

(57) ABSTRACT

A digitally locking coherent receiver and a method of coherently receiving a data signal. One embodiment of the receiver includes: (1) a detector configured to recover a composite signal with respect to a local oscillator signal, the composite signal being a combination of a data signal and a reference signal, and (2) a digital signal processor (DSP) communicably coupled to the detector and configured to recognize and compensate for drift in the local oscillator signal with respect to the reference signal.

### TECHNICAL FIELD

This application is directed, in general, to a digitally locking coherent receiver.

### BACKGROUND

In typical coherent detection, a receiver detects both phase and amplitude of an inbound signal. This is achieved by mixing the inbound signal with a local oscillator (LO) signal before the detection and decision stages of the receiver. The LO signal operates as a normal (a reference) while the signal is detected with respect to the LO signal. Coherent detection is used in a variety of receivers to provide various capabilities, including receiving complex modulation formats, such as quadrature amplitude modulation (QAM) and orthogonal frequency division multiplexing (OFDM), and spectrally sliced receivers for optical super-channel or ultra-wideband analog receivers. Coherent detection is also useful in multiple antenna systems, multi-channel single detector systems, and for mitigating multi-path effects.

Local oscillators in coherent receivers typically have strict requirements. Local oscillators are generally high power, sometimes 20 dB, or more, greater than the signal power. Local oscillators are typically wavelength tunable and have low relative intensity noise (RIN), narrow linewidth and good frequency stability.

### SUMMARY

One aspect provides a receiver. In one embodiment, the receiver includes: (1) a detector configured to recover a composite signal with respect to a local oscillator signal, the composite signal being a combination of a data signal and a reference signal, and (2) a digital signal processor (DSP) communicably coupled to the detector and configured to recognize and compensate for drift (and perhaps any offset) in the local oscillator signal with respect to the reference signal.

Another aspect provides a method of coherently receiving a data signal. In one embodiment, the method includes: (1) coupling the data signal with a reference signal, thereby forming a composite signal, (2) mixing the composite signal with a local oscillator (LO) signal, thereby generating a pair of output signals from which the composite signal is recovered, and (3) reconstructing the data signal with respect to an offset between the reference signal and the LO signal.

Yet another aspect provides a digitally locking coherent optical receiver. In one embodiment, the receiver includes: (1) a plurality of channels respectively having: (1a) a data port and an LO port, each optically coupled to an optical hybrid and respectively operable to receive a composite signal and an LO signal, wherein the composite signal is a combination of a reference signal and a data signal, and (1b) a balanced detector operable to detect sum and difference signals generated by the optical hybrid based on the composite signal and the LO signal, and (2) a DSP configured to reconstruct the composite signal with respect to the LO signal from the sum and difference signals, and employ an observed delta between the LO signal and the reference signal to coherently receive the data signal for each of the plurality of channels.

### BRIEF DESCRIPTION

Reference is now made to the following descriptions taken in conjunction with the accompanying drawings, in which:

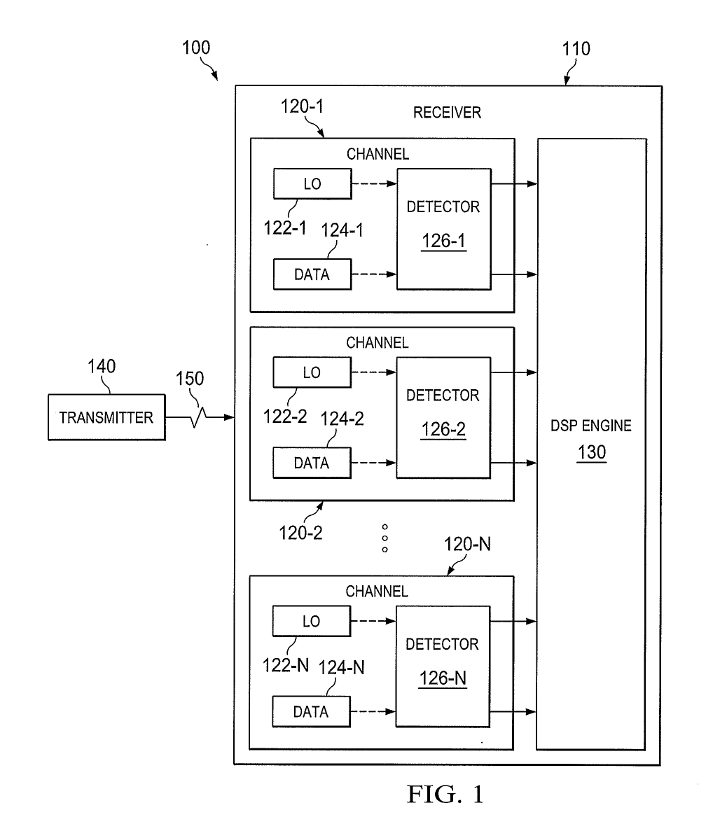

FIG. 1 is a block diagram of a communication system;

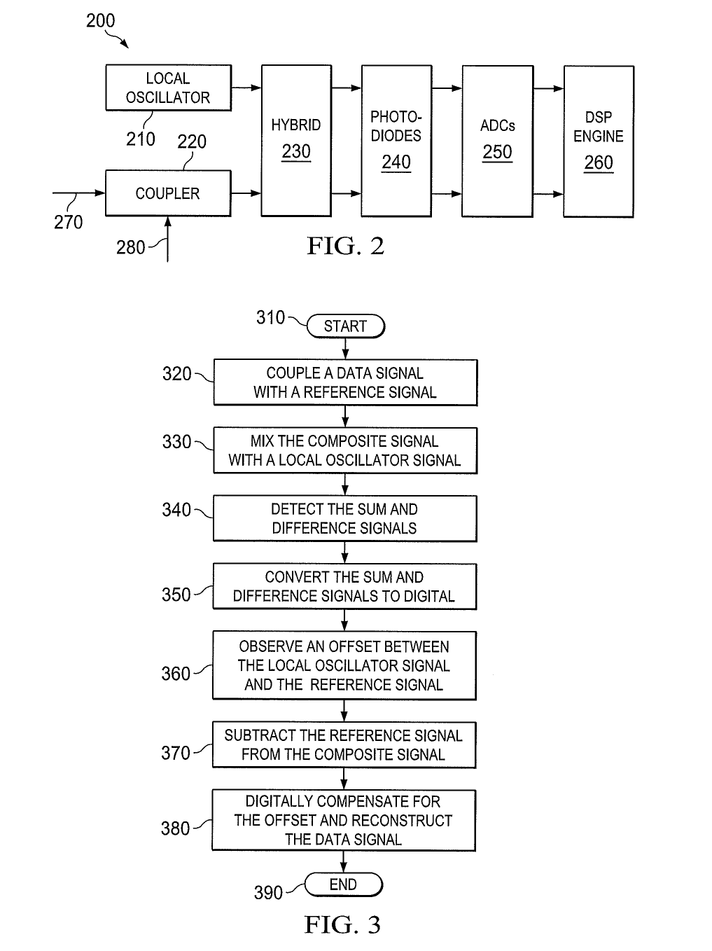

FIG. 2 is a block diagram of one embodiment of a digitally locking receiver;

FIG. 3 is a flow diagram of one embodiment of a method for coherently receiving a data signal.

### DETAILED DESCRIPTION

Coherent detection is a technique by which a transmitted data signal is received in both phase and amplitude. A coherent receiver generally includes an LO port and a signal port for receiving inputs, a detection module for creating electrical signals based on the received inputs, and a digital signal processor (DSP) for reconstructing the data. In a given system, the coherent receiver may have one or more receiving channel, each having an LO port, a signal port and a detection module. Depending on the particular receiver package, each channel can provide its outputs to respective DSPs, or to a single DSP that gathers outputs from all channels.

The detection module for a given channel can be assembled in a variety of ways depending on the transmission frequency and medium. For example, an optical coherent receiver could employ photodetectors or, more specifically, photodiodes. Photodiodes generate analog electrical signals based on sensed light. Analog-to-digital converters (ADCs) then convert the analog electrical signals to digital, such that the DSP can use them.

Similarly, the components necessary for mixing the LO signal and the data signal vary according to frequency and transmission medium. Continuing the example above, an optical coherent receiver could employ an optical hybrid, or “mixer,” that combines the LO signal and the data signal into two independent outputs: a sum signal and a difference signal. Electrical hybrids perform the same task for electrical signals. As is the case for any two-variable system, at least two equations are necessary to solve. Coherent receivers can reconstruct the data signal given the sum signal and the difference signal.

Consequently, the phase and amplitude of the reconstructed data signal are with respect to the LO signal, or are “normalized” to the LO signal. Thus, the integrity of the reconstructed data depends on the quality of the LO signal and the LO itself. Any “drift” in phase or frequency of the LO impacts the reconstructed data unless that drift can be compensated for. The problem intensifies for multi-channel systems, as the phase and frequency of the LO signal must be reconciled across every channel, in addition to over time. Typically the LO signal is repeatedly amplified and split to drive the LO port for each channel. This often introduces significant amounts of noise and degrades the LO signal.

A common approach to improve the LO signal in optical coherent receivers is optical injection locking (OIL). OIL is a technique where a strong “slave” laser emits light with frequency characteristics based on an injected weaker “master” laser. As such, OIL combines the high power and low RIN benefits of the slave laser with the narrow linewidth and frequency stability benefits of the master laser. A limitation of OIL is a limited “capture bandwidth,” which is essentially how near the master and slave laser must be in frequency to lock. Another limitation is that OIL is not an off-the-shelf solution, as slave lasers often require physical modification, including elimination of internal local oscillators, polarization alignment between slave and master lasers, and reduced facet reflectivity on the laser cavity facet through which light is injected.

It is realized herein that the LO signal can be digitally locked to a weak master signal, or “reference” signal, that is injected into the data signal. This can be accomplished by using the DSP to recognize and digitally compensate for drift in the LO. It is also realized herein that digital locking is much more flexible with regards to the frequency of the LO and reference signals. A digitally locking coherent receiver can operate on optical signals and electrical signals.

It is further realized herein that the reference signal should be coupled to the data signal before mixing with the LO signal. The reference signal should be frequency stable and have a narrow linewidth. Frequency stability is assessed over a measurement time window that varies in duration across various applications. One system may use a measurement time window of 500 milliseconds, another may use one second and yet another may use one millisecond. The reference signal is considered frequency stable if it exhibits frequency perturbations of one megahertz (MHz) or less over the measurement time window. For example, if at the beginning of the measurement time window the reference signal is at one gigahertz (GHz), the reference signal should not stray from one GHz by more than one MHz over the measurement time window or, in other words, the reference signal should remain in the range of 0.999 GHz to 1.001 GHz, inclusive, for the duration of the measurement time window. The reference signal is considered to have a narrow linewidth if its linewidth is no greater than one MHz. Ideally, the absolute frequency of the reference signal should be within the absolute bandwidth occupied by the data signal. The benefit of this arrangement is that no further bandwidth requirements are imposed on the detection and decision components of the receiver to accommodate the reference signal. However, a reference signal having a frequency outside the bandwidth of the data signal is still acceptable, so long as the bandwidth of the detection components can sense that frequency. Coupling the data signal and reference signal forms a composite signal. The composite signal contains a tone representing the reference signal in the time domain, and a peak representing the reference signal in the frequency domain.

As would be the case for a data signal in a typical coherent receiver, the composite signal can be sensed and reconstructed with respect to the LO signal. However, it is realized herein that the reconstructed composite signal exhibits a peak representing a frequency delta, or offset, between the reference signal and the LO signal. The DSP can observe this offset and use it to compensate for drift in the LO. Additionally, given knowledge of the reference signal, the reference signal can be subtracted from the reconstructed composite signal, leaving the data signal.

It is further realized herein that digital locking is freely scalable to multi-channel systems. A single reference signal can be coupled into the data signal for each channel, and the LO requirements are relaxed considerably. In fact, each channel can employ its own LO. It is also realized herein that, although the reference signal is low power, sometimes lower power than the data signal itself, its narrow linewidth and frequency stability allow it to be easily observed by the DSP among the relatively wideband data signal. Splitting the reference signal among multiple channels has little impact on the digital locking. The DSP can digitally shift each reconstructed data signal to any frequency relative to the reference signal.

Before describing various embodiments of the digitally locking coherent receiver and method of coherently receiving a data signal introduced herein, a communication system within which the digitally locking coherent receiver and method may be embodied or carried out will be described.

FIG. 1 is a block diagram of a communication system 100 within which a digitally locking coherent receiver or method of coherently receiving a data signal may be embodied or carried out. Communication system 100 includes a transmitter 140 configured to transmit a signal 150 toward a receiver 110.

Receiver 110 includes N channels, channel 120-1 through channel 120-N, and a DSP engine 130. Each channel is configured to detect a data signal with respect to an LO signal. In certain embodiments, each channel detects a different signal. The different signals may be different frequency “slices” of a larger, wide-band signal, or they may be entirely unrelated. In other embodiments, the same signal is detected by each channel, and a single data signal is reconstructed by DSP engine 130. The LO signal can be generated by a single LO, which would then be split and amplified numerous times. Alternatively, in certain embodiments, each channel or group of channels uses its own LO.

Each of the N channels includes an LO port, a data port and a detector. For example, channel 120-N includes LO port 122-N, data port 124-N and detector 126-N. When received, signal 150 is directed to data port 124-N, while an LO signal drives LO port 122-N. Detector 126-N uses a combination of the signals present at LO port 122-N and data port 124-N to generate a pair of digital inputs to DSP engine 130. Given the pair of digital inputs, DSP engine 130 reconstructs signal 150. DSP engine 130 is capable of coherently receiving signal 150 because both the phase and amplitude components of signal 150 can be recovered when detected with respect to the LO signal.

The ability to coherently receive a data signal is helpful for employing multiple receiver channels, such as channel 120-1 through channel 120-N. For example, certain systems use multiple antennas to mitigate multi-path effects. Errors apparent at receiver 110 are corrected by receiving the signal with multiple channels. DSP engine 130 considers the recovered signal from each channel in determining the actual content of the received signal. To achieve this, each channel's detector should be referenced to the same signal.

Having described a communication system within which a digitally locking coherent receiver or method of coherently receiving a data signal may be embodied or carried out, several embodiments of the receiver and method introduced herein will be described.

FIG. 2 is a block diagram of one embodiment of a digitally locking receiver, receiver 200. Receiver 200 includes an LO 210, a coupler 220, a hybrid 230, photodiodes 240, analog-to-digital converters (ADCs) 250 and a DSP engine 260.

Coupler 220 couples a data signal 270 and a reference signal 280 to form a composite optical signal. Data signal 270 is the signal desired to be recovered by receiver 200. Reference signal 280 should be a frequency-stable low power signal.

Reference signal 280 should also have a narrow line width, which lends itself to lower power implementations. The power of reference signal 280 can be lower than that of data signal 270 and, in certain embodiments, ten or more times weaker. The resulting composite optical signal exhibits a discrete frequency tone in the time domain, and a narrow peak in the frequency domain. The peak would appear along with the full spectrum of data signal 270. Reference signal 280 is typically in the bandwidth of data signal 270, but is not necessarily so. Having reference signal 280 within the bandwidth of data signal 270 relieves the need for wider band receiver components. Although reference signal 280 is potentially lower power than data signal 270, its peak stands out due to the narrow line width.

Hybrid 230 is employed as an optical mixer having two inputs and at least two outputs. The inputs to hybrid 230 are the composite optical signal created by coupler 220 and an LO signal generated by LO 210. The LO signal should be higher power with low relative intensity noise (RIN). Hybrid 230 produces two independent outputs based on the LO signal and the composite signal: a sum and a difference.

Photodiodes 240 are configured to detect the sum and difference signals from hybrid 230. Upon detection, photodiodes 240 emit analog electrical sum and difference signals to ADCs 250. ADCs 250 then convert the analog sum and difference signals to digital, so they can be processed by DSP engine 260.

Given the digital sum and difference signals, DSP engine 260 can reconstruct the composite signal. Because the composite signal was detected with respect to the LO signal, the reconstructed composite signal includes a peak representing a frequency delta between reference signal 280 and the LO signal. DSP engine 260 observes this delta and uses it in reconstructing data signal 270. Any changes, or “drift,” in the LO signal are also observed by DSP engine 260 and can be compensated for by digitally shifting the reconstructed composite signal, thereby digitally locking at a desired frequency. Given knowledge of the frequency and amplitude characteristics of reference signal 280, DSP engine 260 can also subtract reference signal 280 from the reconstructed composite signal. In certain embodiments, in which the DSP engine uses an adaptive digital filter for signal equalization, the adaptive filter can automatically subtract or suppress the reference signal.

The ability to digitally lock on to an arbitrary frequency offset relieves the demand for well stabilized local oscillators. Additionally, it is no longer necessary to split and amplify a single LO to provide a constant reference across multiple receiver channels. Each receiver channel could employ its own LO having unique frequency and phase characteristics. In these circumstances, each receiver channel would receive a composite signal formed with the same reference signal, and DSP engine 260 compensates each channel for whatever drift is observed in its respective LO.

FIG. 3 is a flow diagram of one embodiment of a method for coherently receiving a data signal. The method begins in a start step 310. A data signal is combined with a reference signal in a coupling step 320. The resulting composite signal is mixed with an LO signal in a mixing step 330. The independent outputs of the mixing are sum and difference signals that are detected in a detecting step 340. In a conversion step 350, the detected sum and difference signals are converted from analog to digital. Given the digital sum and difference signals, the composite signal is reconstructed, within which an offset between the LO signal and the reference signal is observed in an observing step 360. The reference signal is subtracted from the reconstructed composite signal in a subtraction step 370, leaving a data signal reconstructed with respect to the LO signal. In a digital locking step 380, the reconstructed data signal is digitally shifted to compensate for the offset observed in observing step 360. The method then ends in an step 390.

Those skilled in the art to which this application relates will appreciate that other and further additions, deletions, substitutions and modifications may be made to the described embodiments.

What is claimed is:

1. A receiver, comprising:
a detector configured to recover a composite signal with respect to a local oscillator signal, said composite signal being a combination of a data signal and a reference signal; and
a digital signal processor (DSP) communicably coupled to said detector and configured to recognize and compensate for drift in said local oscillator signal with respect to said reference signal.

2. The digitally locking receiver recited in claim 1 wherein said reference signal has a line width below one megahertz.

3. The receiver recited in claim 1 wherein said DSP is operable to observe a frequency offset between said local oscillator signal and said reference signal.

4. The receiver recited in claim 3 wherein said DSP is further operable to subtract said reference signal from said composite signal to recover said data signal.

5. The receiver recited in claim 1 wherein said detector is further configured to detect a sum and difference of said composite signal and said local oscillator signal, from which said composite signal is recovered.

6. The receiver recited in claim 5 wherein said detector comprises:
a balanced pair of photodiodes operable to optically receive said sum and difference; and
a pair of analog to digital converters (ADCs) respectively, electrically coupled to said balanced pair of photodiodes and communicably coupled to said DSP.

7. The receiver recited in claim 6 further comprising an optical hybrid having input ports configured to receive said composite signal and said local oscillator signal are received and output ports optically coupled to said detector, and configured to generate said sum and difference based on said local oscillator signal and said composite signal.

8. A method of coherently receiving a data signal, comprising:
coupling said data signal with a reference signal, thereby forming a composite signal;
mixing said composite signal with a local oscillator (LO) signal, thereby generating a pair of output signals from which said composite signal is recovered; and
reconstructing said data signal with respect to an offset between said reference signal and said LO signal.

9. The method recited in claim 8 wherein said pair of output signals are a sum and a difference of said composite signal and said LO signal.

10. The method recited in claim 8 wherein further comprising detecting and converting said pair of output signals to digital signals.

11. The method recited in claim 8 wherein said reconstructing includes observing said offset and digitally compensating for drift in said LO signal in coherently detecting said data signal, based on said offset.

12. The method recited in claim 8 wherein said reconstructing includes subtracting said reference signal from said composite signal.

13. The method recited in claim 8 wherein said reconstructing includes digitally locking said LO signal at a frequency relative to the frequency of said reference signal.

14. The method recited in claim 13 wherein said reference signal has a narrow line width and is frequency-stable.

15. A digitally locking coherent optical receiver, comprising:
a plurality of channels respectively having:
a data port and a local oscillator (LO) port, each optically coupled to an optical hybrid and respectively operable to receive a composite signal and an LO signal, wherein said composite signal is a combination of a reference signal and a data signal, and
a balanced detector operable to detect sum and difference signals generated by said optical hybrid based on said composite signal and said LO signal; and
a digital signal processor (DSP) configured to reconstruct said composite signal with respect to said LO signal from said sum and difference signals, and employ an observed delta between said LO signal and said reference signal to coherently receive said data signal for each of said plurality of channels.

16. The digitally locking coherent optical receiver recited in claim 15 wherein respective composite signals received by said plurality of channels are combinations of a single reference signal and a plurality of data signals.

17. The digitally locking coherent optical receiver recited in claim 15 wherein said reference signal exists in the frequency band of said data signal, and both said reference signal and said data signal vary among said plurality of channels.

18. The digitally locking coherent optical receiver recited in claim 15 wherein respective composite signals received by said plurality of channels are combinations of a single reference signal and a single data signal.

19. The digitally locking coherent optical receiver recited in claim 15 wherein said plurality of channels are respectively operable to receive a plurality of LO signals.

20. The digitally locking coherent optical receiver recited in claim 15 wherein each of said plurality of channels includes an optical coupler optically coupled to said data port and configured to generate said composite signal by coupling said reference signal and said data signal.
